(19) United States
(12) Patent Application Publication
(10) Pub. No.: US 2010/0227198 A1
(43) Pub. Date: Sep. 9, 2010

(54) Thermal Insulation Layer System

(76) Inventor: Stefan Lampenscherf, Poing (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/225,326

(22) PCT Filed: Jan. 17, 2007
(86) PCT No.: PCT/EP2007/050425

§ 371 Date: Sep. 18, 2008

(30) Foreign Application Priority Data
Mar. 22, 2006 (DE) 10 2006 013 215.7

(51) Int. Cl. B32B 9/04

(52) U.S. Cl. 428/702; 428/411.1

(57) ABSTRACT

In order to improve the resistance of heat insulation layers, in particular under the stresses due to high surface temperatures and temperature transients which are typical of gas turbines, a thermal insulation layer system which has a first main side which is provided for arrangement adjoining a component to be protected thermally and a second main side which is provided for arrangement adjoining a hot environment is proposed. The thermal insulation layer system has sections having different coefficients of thermal expansion.

### CROSS REFERENCE TO RELATED APPLICATIONS

This application is the US National Stage of International Application No. PCT/EP2007/05025, filed Jan. 17, 2007 and claims the benefit thereof. The International Application claims the benefits of German application No. 10 2006 013 215.7 filed Mar. 22, 2006, both of the applications are incorporated by reference herein in their entirety

### FIELD OF INVENTION

The invention relates to a thermal insulation layer system with a first main side which is designed to be arranged adjoining a component to be given thermal protection and with a second main side which is designed to be arranged adjoining a hot environment.

### BACKGROUND OF THE INVENTION

In addition to a cost-effective process technology, a prerequisite for the efficient use of ceramic thermal insulation layers in gas turbines is above all the structural stability and thereby the reliability of the thermal insulation layer under typical usage conditions of the gas turbines. Thus for example a trouble-free service life of over 25,000 operating hours must be guaranteed in the field of power station applications, with this period corresponding to the desired service interval. A premature failure of the thermal insulation layer system would lead to overheating of the base material and possibly to damage to the turbine. The downtime and rectification costs arising from this can be considerable and under some circumstances can nullify the technological benefit of the thermal insulation layer system.

Increasing efficiency has a central role to play on the road to generating energy in a resource-saving and environmentally-friendly manner. The decisive parameter for the increasing the efficiency of gas turbines is the turbine inlet temperature. In order to increase the efficiency of gas turbines from appr. 38 at a turbine inlet temperature of 1230° C. (ISO) to 45, it is necessary to raise the turbine inlet temperature to appr. 1350° C. This objective can be achieved by employing ceramic thermal insulation layers and also by using improved basic materials and effective cooling methods. In such cases the thermal insulation effect of the ceramic thermal insulation layer, while preserving the same cooling conditions, depending on the thickness of the thermal insulation layer, enables the permitted surface temperature to be increased by several 100K.

Different options for enabling the durability of thermal insulation layers to be guaranteed and improved under the typical stresses for gas turbines imposed by high surface temperatures and temperature transients are known from the prior art:
1. By using sinter-resistant ceramic materials the temperature resistance of the thermal insulation layer can be improved. This enables the increasing compression of the thermal insulation layer material and the associated shrinkage processes of the thermal insulation layer at high temperature to be restricted.
2. By deliberately making microcracks or trough structures, known as engravings, in the thermal insulation layer, the expansion tolerance of the thermal insulation layer can be increased. In this case a tight network of stress-relieving cracks and stress-relieving troughs is deliberately created, which allows the stress limit for the occurrence of engraving defects to be increased.
3. The suppression of phase transitions in a predetermined temperature range, e.g. by stabilizing the tetragonal phase of ZrO₂ by an Yttrium doping and the associated effects, e.g. a volume expansion on conversion, leads to a significant reduction in the stress on the thermal insulation layer.
4. A reduction in the damage to the thermal insulation layer is also effected by the adaptation of the coefficient of thermal expansion of the thermal insulation layer to the metallic base material of the component for which thermal protection is to be provided. By matching the coefficient of thermal expansion of the thermal insulation layer to the coefficient of thermal expansion of the base material the size of the expansions arising as a result of incorrect adaptation in the thermal insulation can be reduced, especially in the vicinity of the surface between the thermal insulation layer and adhesion agent layer of the base material.

### SUMMARY OF INVENTION

The object of the invention is to further improve the durability of thermal insulation layers, especially under typical stresses for gas turbines imposed by high surface temperatures and temperature transients.

This object is achieved by a thermal insulation layer system with the features of the claims. Advantageous embodiments emerge from the dependent claims.

An inventive thermal insulation layer system features a first main side which is designed to be arranged adjacent to a component to be thermally protected and a second main side which is designed to be arranged adjacent to a hot environment. Inventively the thermal insulation layer system has sections with different coefficients of thermal expansion.

The invention is based on the knowledge that, by harmonizing the coefficients of thermal expansion of the thermal insulation layer and of the base material of the component to be thermally protected, a reduction of the expansion of the thermal insulation layer in the vicinity of a boundary surface between the thermal insulation layer and an adhesive agent layer joining the thermal insulation layer and the base material can actually be achieved. However, because of the large difference in temperature between the second main side of the thermal insulation layer and the first main side of the thermal insulation layer which forms the boundary surface, this can cause significant expansions at the second main side to arise. This can especially be the case with what is known as heating-up or cooling-down shock. The expansions increase in such cases with the size of the coefficient of thermal expansion and the difference in temperature between the first and the second main side. A unilateral adaptation of the coefficient of thermal expansion of the thermal insulation layer to the relatively large coefficient of thermal expansion of the base material, which as a rule consists of a metal (e.g. nickel-base super alloy), therefore has an adverse effect on the second main side. In particular with the trend mentioned at the start towards higher surface temperatures there is an increasing risk of damage.

To get around this problem the invention therefore proposes a thermal insulation layer system featuring sections with different coefficients of thermal expansion. This enables expansions which are too great in the area of the second main side of the thermal insulation layer system to be avoided. The risk of damage is thus reduced.

In particular there is provision for a first section of the thermal insulation layer system adjoining the component to be given thermal protection to have a first thermal expansion coefficient which is matched to the thermal expansion coefficient of the component. Furthermore at least one second section of the thermal insulation layer system has a second, smaller thermal expansion coefficient. The invention is thus based on the principle of reducing the thermal expansion coefficient in sections with increasing temperature over the thermal insulation layer system.

The second section adjacent to the second main side has the smallest coefficient of thermal expansion of the thermal insulation layer system, which minimizes the expansions on the second main side of the thermal insulation layer system. The second coefficient of thermal expansion of the second section adjacent to the second main side is selected so that the expansions occurring under typical operating conditions at the second main side lie in a specified range. This specified range can be determined by measurement of the expansion tolerance depending on the temperature of the thermal insulation layer system. The optimum size for the coefficient of thermal expansion can be determined by comparing the results of stress simulations with the measured expansion tolerance range.

It is sufficient for the thermal insulation layer system to be embodied as a composite consisting of a first thermal insulation layer, which faces towards the component to be thermally protected, and a second thermal insulation layer which faces towards the hot environment. The provision of only two thermal insulation layers represents the simplest possible structure, so that the thermal insulation layer system is able to be provided in a simple and comparatively cost-effective way. This does naturally not exclude the possibility of the thermal insulation layer system being embodied as a composite of more than two layers.

It has been shown to be expedient for the first thermal insulation layer to have a coefficient or thermal expansion in the range of 1.0·10⁻⁵K⁻¹. In one embodiment the second thermal insulation layer then includes a coefficient of thermal expansion in the range of 8.0·10⁻⁶K⁻¹.

The thermal insulation layer system can be embodied from one of the following material combinations, with the first value designating the material of the first thermal insulation layer and the second value designating the material of the second thermal insulation layer:
7YSZ/LA2Hf2O7;
7YSZ/BaZrO3;
7YSZ/LaYbO3,

with 7YSZ=Zirconium oxide, stabilized with 7% by weight % Yttrium oxide. At a temperature of 1000° C. the coefficients of thermal expansion CTE are as follows:
CTE_{7YSZ}˜10⁻⁵K⁻¹;
CTE_{LaHfO}˜8.0 10⁻⁶K⁻¹;
CTE_{BaZrO}˜8.3 10⁻⁶K⁻¹;
CTE_{LaYbO}˜8.6 10⁻⁶K⁻¹.

To achieve a high mechanical stability the first and the second thermal insulation layer are connected to each other by a plasma spray method.

### BRIEF DESCRIPTION OF THE DRAWINGS

The invention and its benefits will be explained in more detail below with reference to the figure's. These show:

FIG. 1 a cross-section through an inventive heat insulating layer system which is applied to a component to be given thermal protection, and

FIG. 2 an x-y diagram showing the expansions occurring on the surface of the thermal insulating layer under typical operating conditions of a gas turbine.

### DETAILED DESCRIPTION OF INVENTION

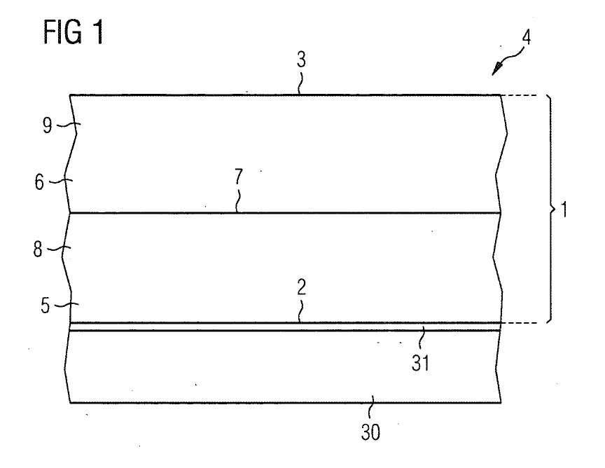

FIG. 1 shows a cross-sectional diagram of an inventive thermal insulating layer system 1. The thermal insulating layer system 1 is applied with a first main side 2 over an adhesion agent layer 31 to a component 30 to be given thermal protection. The component 30 to be given thermal protection consists of a metal for example, e.g. a Nickel-base super alloy. The component 30 to be given thermal protection can for example represent the blades of a gas turbine. With a second main side 3 the thermal insulation layer system 1 is subjected to a hot environment 4.

The thermal insulation layer system 1 typically features a first section 5 and a second section 6 each with a different coefficient of thermal expansion CTE1, CTE2. Whereas the first section 5 is adapted in its coefficient of thermal expansion CTE1 to the coefficient of thermal expansion of the material of the component 30, the material of the second section 6 is embodied from a temperature-stable material that has a lower coefficient of thermal expansion CTE2 than the first section 5.

The thermal insulation layer system 1 is embodied as a combination of a thermal insulation layer 8 and a thermal insulation layer 9, which are joined to each other for example in a plasma spray method in the area of a boundary plane. In this case thermal insulation layer 8 forms the first section 5 and thermal insulation layer 9 the second section 6.

The sections with different coefficients of thermal expansion of the thermal insulation layer system 1 enable the risk of damage to the thermal insulation layer to be significantly reduced, especially in the case of cooling down. On the other hand the option is also provided of increasing the permitted surface temperature, meaning the temperature on the second main side 3 of the thermal insulation layer system, which, as described above, produces an enhanced efficiency when used in gas turbines.

The invention thus represents an extension of the previously provided adaptation of the coefficient of thermal expansion of the thermal insulation layer to the base material of the component 30 used by additional adaptation to the expected spatial and temporal curve of the temperature over the thickness of the thermal insulation layer system 1. This allows the mechanical stresses arising in the thermal insulation layer or the thermal insulation layer system to be reduced and especially the usage limits to be increased in relation to the maximum surface temperature.

As shown by way of example in FIG. 1, the first and the second thermal insulation layer 8, 9 can have approximately the same thickness. The total thickness of the inventive thermal insulation layer system 1 roughly corresponds in this case to the thickness of a conventional thermal insulation layer. The first thermal insulation layer adjacent to the component 30 to be given thermal protection consists for example of 7YSZ (Zirconium oxide, stabilized with 7% by weight Yttrium oxide), with this material having a coefficient of thermal expansion of appr. 10⁻⁵K⁻¹ at 1000° C. The material of the second thermal insulation layer 9 adjoining the hot environment is for example embodied from one of the following materials, with the coefficient of thermal expansion at 1000° C. being specified in each case.
7YSZ/LA2Hf2O7, with CTE_{LaHfO} (1000° C.)˜8.0-10⁻⁶K⁻¹;
7YSZ/BaZrO3, with CTE_{BaZrO} (1000° C.)˜8.3-10⁻⁶K⁻¹;
7YSZ/LaYbO3, with CTE_{LaYbO} (1000° C.).˜8.6 10⁻⁶K⁻¹.

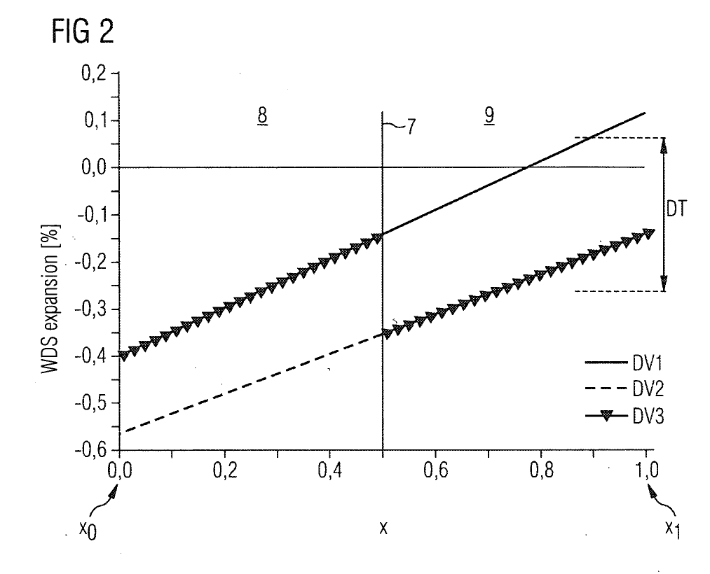

FIG. 2 shows the curve of the expansion of the thermal insulation layer system 1 over its thickness x. The normalized position x in the thermal insulation layer system 1 is plotted on the x axis. x₀ identifies the boundary surface (meaning the first main side 2) of the thermal insulation layer system 1 to the adhesion agent layer 31. x₁ identifies the surface, meaning the second main side 3, of the thermal insulation layer system 1. The expansion in the respective thermal insulation layer 8 (with a coefficient of thermal expansion CTE1) and 9 (with a coefficient of thermal expansion CTE2) is shown on the y axis (“WDS expansion”). A negative value in this case indicates a compression expansion, a positive value a tension expansion.

The figure shows the curve of the expansion in an operating state after cooling down. It is based on the assumption that the overall arrangement of the heat insulation layer system 1, which is applied to the component 30 to be given thermal protection, is stress-free during operation at high temperatures.

To better illustrate the invention a total of three expansion curves DV1, DV2 and DV3 are shown in the figure. DV1 indicates the expansion curve in the first thermal insulation layer 8, which is provided adjacent to the component 30 to be given thermal protection. DV1 has a solid line. DV2 indicates the expansion curve in the second thermal insulation layer 9, which adjoins the hot environment 4. DV2 has a dashed line. Expansion curves DV1 and DV2 are in this case each shown for purposes of Illustration over the entire thickness x, and not only in the relevant thermal insulation layer 8 or 9. DV3 finally indicates the expansion curve in the inventive thermal insulation layer system 1, which in the region of the boundary plane 7 formed between the first and the second thermal insulation layer 8, 9 shows a jump.

The effect of the reduced coefficient of thermal expansion CTE2 of the material of the second thermal insulation layer 9 is that the expansions occurring during typical operating conditions on the surface of the thermal insulation layer system (x₁ of the x axis) lie within a specified range DT of expansion tolerance. The range DT can be defined by a measurement of the expansion tolerance as a function of the temperature of the thermal insulation layer system 1. The optimum value of the coefficient of thermal expansion, which is located in the rise of the section of the curve running in the area between x=0.5 and x=1.0, must then be determined from the comparison of the results of a stress simulation with measured expansion tolerance areas.

The effect of the inventive method is that the expansion curve in the thermal insulation layer system 1 does not lie in the compression expansion area (cf. expansion curve DV3, which lies within the area x₁ within the specified area DT). This allows the vertical stresses on the surface damaging the overall arrangement (second main side 3) to be avoided.

1.-9. (canceled)

10. A thermal insulation layer system having sections with different coefficients of thermal expansion, comprising:
a first main side arranged on a component to be given thermal protection; and
a second main side arranged adjoining a hot environment,
wherein a first section of the thermal insulation layer system which adjoins the component to be given thermal protection features a first coefficient of thermal expansion adapted to a coefficient of thermal expansion of the component, and
at least one further section of the thermal insulating layer system that features a smaller coefficient of thermal expansion than the first coefficient of thermal expansion.

11. The thermal insulation layer system as claimed in claim 10, wherein the further section adjoins the second main side and has the smallest coefficient of thermal expansion of the thermal insulation layer system.

12. The thermal insulation layer system as claimed in claim 11, wherein the smaller coefficient of thermal expansion of the further section adjoining the second main side is selected such that expansions occurring in typical operating conditions on the second main side lie in a specified range.

13. The thermal insulation layer system as claimed in claim 12, wherein the layer system is a composite of a first thermal insulation layer that faces the component to be given thermal protection, and a second thermal insulation layer which faces the hot environment.

14. The thermal insulation layer system as claimed in claim 13, wherein the first thermal insulation layer has a coefficient of thermal expansion of approximately 1.0·10⁻⁵K⁻¹.

15. The thermal insulation layer system as claimed in claim 13, wherein the second thermal insulation layer has a coefficient of thermal expansion of approximately 8.0·10⁻⁶K⁻¹.

16. The thermal insulation layer system as claimed in claim 13, wherein the layer system material is selected from the groups consisting of: 7YSZ/LA2Hf2O7, 7YSZ/BaZrO3, and 7YSZ/LaYbO3,
where 7YSZ=Zirconium oxide, stabilized with 7% by weight % Yttrium oxide, and
where the first value designating the material of the first thermal insulation layer and the second value the material of the second thermal insulation layer.

17. The thermal insulation layer system as claimed in claim 16, wherein the first and the second thermal insulation layers are joined to each other by a plasma spray method.
